(19) United States
(12) Patent Application Publication
(10) Pub. No.: US 2026/0330609 A1
(43) Pub. Date: Oct. 22, 2026

(54) STYLE STANDARDIZATION AND QUALITY ENHANCEMENT OF RETINAL IMAGES

(71) Applicant: Optain Health, Inc., Charlotte, NC (US)

(72) Inventors: Zongyuan Ge, Melbourne (AU); Mingguang He, Hong Kong (CN); Chi Liu, Melbourne (AU); Wei Meng, Melbourne (AU); Jason Sun, Melbourne (AU)

(73) Assignee: Optain Health, Inc., Charlotte, NC (US)

(21) Appl. No.: 19/730,612

(22) Filed: Jul. 2, 2026

Related U.S. Application Data
(63) Continuation of application No. PCT/US2025/010057, filed on Jan. 2, 2025.
(60) Provisional application No. 63/618,097, filed on Jan. 5, 2024.

(51) Int. Cl. G06T 5/60; G06T 5/50; G06T 7/00

(52) U.S. Cl. CPC G06T 5/60; G06T 5/50; G06T 7/0012; G06T 2207/10024; G06T 2207/10064; G06T 2207/10101; G06T 2207/20081; G06T 2207/20084; G06T 2207/30041

(57) ABSTRACT

The present disclosure relates to techniques for achieving cross-domain generalization and robustness of machine-learning models through preprocessing techniques involving style standardization and quality enhancement in disease diagnosis. The disclosed techniques may involve constructing a reference dataset of images with a standard style and standard quality from a single domain and generating degraded versions of these images. A template capturing the reference style and quality may be learned by comparing reference images with their degraded counterparts using a dissimilarity-based framework. A reverse transformation model may be utilized to generate transformed images based on the learned template and the degraded images. In some aspects, the image degradation model and the reverse transformation model may be embedded into downstream machine-learning models to align diverse-domain retinal images with the reference style and the reference quality, thereby reducing cross-domain variance and enhancing models’ robustness against noisy or low-quality data during disease diagnosis.

### CROSS-REFERENCE TO RELATED APPLICATIONS

This application is a continuation of International Patent Application No. PCT/US2025/010057, filed on Jan. 2, 2025, which claims the priority to and the benefit of U.S. Provisional Application Number 63/618,097, filed on Jan. 5, 2024. The entire disclosures of the aforementioned applications are incorporated by reference herein in their entireties for all purposes.

### BACKGROUND

Retinal imaging is extensively employed in diagnosis and management of numerous diseases, offering clinicians insights for early detection and intervention. However, the effectiveness of these imaging technologies is often hindered by inconsistencies in image quality and style. Variations in imaging protocols, equipment, and environmental factors across healthcare facilities may result in significant discrepancies in the quality and characteristics of medical images. These inconsistencies may pose a major challenge for the development and deployment of reliable, artificial intelligence (AI)-powered diagnostic systems.

Due to the complexity and uncertainty of real-world clinical scenarios, the reliability and robustness of deep learning models when deployed in practice may be a concern. One challenge may involve cross-domain generalization ability during inference or testing. Deep learning models often overfit to a specific domain distribution of training data. As a result, when these models are applied to new domains with differing characteristics or distributions, their performance may degrade considerably. For example, a model trained on images captured under specific conditions (e.g., desktop cameras) may struggle to maintain its accuracy when tested on images captured in different settings (e.g., handheld cameras). Similarly, models trained on data from one population or demographic group may not perform as well when applied to data from other groups, resulting in performance disparities. This problem may highlight the significance of models to generalize effectively across diverse, real-world situations.

Additionally, robustness of these models against image quality degradation may also be a concern. Deep learning models are typically trained on quality-controlled high-quality images or photos. When faced with low-quality images that may be consequent of, particularly in medical imaging, poor user cooperation, unstable imaging, or non-stringent photography conditions, there may be a notable performance decline. Domain adaptation methods are commonly employed to enhance the effectiveness of machine-learning or deep learning models in new domains. However, these methods normally require target domain data, which may not always be accessible or sufficient for adaptation of the deep learning model. Moreover, these approaches typically cover a limited number of specific domains and quality conditions, necessitating frequent retraining of deployed models for different test domains. Therefore, innovative solutions to harmonize data variability and improve diagnostic consistency may be effective.

### SUMMARY

Some embodiments of the present disclosure relate to techniques for achieving cross-domain adaptation and robustness for a machine-learning model by leveraging a preprocessing technique that includes style standardization and quality enhancement. A reference dataset comprising a plurality of high-quality images may be constructed from an image database. The reference dataset may serve as a basis (or reference) for transforming real-world images into high-quality images that conform to (or closely resemble) a reference style and a reference quality of the reference dataset. These high-quality images may be then used by the downstream machine-learning model for achieving cross-domain adaptation. The term “reference style”, as used herein, may refer to characteristics or attributes of images (e.g., texture, contrast, lighting conditions) that domain experts may consider as representative and relevant for diagnosing a specific medical condition. The reference style may be defined based on a carefully curated set of images through consensus of expert radiologists, pathologists, or other medical professionals with expertise for in a specific medical condition or disease. The term “reference quality” may refer to the attributes of images such as resolution, clarity, detail, as determined by the domain experts for accurate diagnosis of the specific medical condition.

In some aspects of the present disclosure, the reference dataset may include retinal images that may be captured using various imaging modalities such as color fundus photography (CFP), optical coherence tomography (OCT), and fluorescence angiography (FA). For constructing the reference dataset, an input may be received from the domain experts on a style and a quality of the images of the image database. The images with the reference style and the reference quality as determined by the input received from the domain experts may be selected to construct the reference dataset. For example, for retinal images, the input or the feedback from the domain experts such as ophthalmologists may include quality criteria e.g., image resolution, signal-to-noise ratio (SNR) and style criteria e.g., color palette, texture, lighting etc. In some other examples, the input on the style and quality of the image may include a reference image that serves as a benchmark for the selection of subsequent reference images.

For each image of the reference dataset, an image degradation model may be used to generate multiple degraded images by removing the reference style and reducing the reference quality of the images of the reference dataset. The quality degradation may be performed by simulating poor-quality images from the reference images, for example, by adding different types of random noises, such as blurs, masks, mosaic, and shadow into the image, or adjusting the image color jitter, contrast and illumination. The image degradation model may then remove the style representation while keeping structural invariance of the reference images. The structural invariant style removal may include removing low-frequency components, which reflect the style details and retaining high-frequency components that may represent the structure details.

Following the generation of the degraded images, each of these images may be compared with its corresponding reference image using a dissimilarity function to learn a template of the reference style and the reference quality of the reference images. The learned template may represent the reference style and the reference quality of the reference images, modeled using a template learning model. Moreover, the comparison may involve generating feature vectors for both the reference and the degraded images using a deep learning model, followed by computing a distance metric between the feature vectors for quantifying perceptual dissimilarity. For example, the distance metric may include calculating a pixel-wise distance such as mean squared error (MSE), or structural similarity (SSIM) or Euclidean distance based on feature vectors for training the reverse transformation model.

Based on the learned template and the degraded images, a reverse transformation model may be configured to generate transformed images that may align with the reference style and the reference quality of the reference images. The reverse transformation model may be a generative artificial intelligence (AI) model, trained using self-supervised learning methods such as auto-encoders, generative adversarial networks (GANs), or diffusion models. The reverse transformation model may take the degraded images as input and learn to reconstruct their original high-quality counterparts by capturing the style and quality characteristics of the reference dataset. Moreover, the reverse transformation model may analyze both perceptual and pixel-level dissimilarities between the degraded and reference images to enhance its capability to restore the reference style and quality. Once trained, the reverse transformation model may serve as an intermediary processing component, aligning the style and quality of images from diverse or new domains with the learned reference characteristics. This alignment may reduce inconsistencies caused by cross-domain variations, improve image quality, and enhance the performance of downstream machine-learning models in tasks such as disease diagnosis.

The image degradation model and the image transformation model may be deployed as part of preprocessing in a downstream machine-learning pipeline to achieve cross-domain generalization and robustness for disease diagnosis.

The technique disclosed in the present disclosure may be utilized as a preprocessing technique to enhance image-based deep learning pipelines in order to achieve cross-domain generalization and robustness.

In some embodiments, a system is provided that includes one or more data processors and a non-transitory computer-readable storage medium containing instructions which, when executed on one or more data processors, cause one or more data processors to perform part or all of one or more methods disclosed herein.

In some embodiments, a computer-program product is provided that is tangibly embodied in a non-transitory machine-readable storage medium, where the computer-program product includes instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures.

FIG. 1 provides an overview of a cross-domain generalization model employed for preprocessing images in a disease diagnosis model in accordance with various aspects of the present disclosure.

FIG. 2 shows an overview block diagram of the cross-domain generalization model for generating transformed images using the images accessed from an image database.

FIG. 3 shows an example block diagram of dataset construction of a reference dataset comprising reference images of a reference style and a reference quality in accordance with some aspects of the present disclosure.

FIG. 4 illustrates exemplary components of an image degradation model configured to perform style removal and quality degradation of the reference images, enabling the generation of degraded images.

FIG. 5 illustrates an exemplary block diagram of a style removal module for processing the reference images from the reference dataset to generate the degraded images.

FIG. 6 illustrates a block diagram of a quality degradation module for generating the degraded images in accordance with some aspects of the present disclosure.

FIG. 7 illustrates a block diagram of learning a template of the reference style and the reference quality by a dissimilarity function using the reference dataset in accordance with some aspects of the present disclosure.

FIG. 8 illustrates a block diagram of a reverse transformation model for generating the transformed images based on the degraded images and the learned template in accordance with some embodiments of the present disclosure.

FIG. 9 shows exemplary pipelines of training and testing an image-based disease diagnosis model with cross-domain generalization as preprocessing, in accordance with some embodiments of the present disclosure.

FIG. 10 shows an example flowchart for generating the transformed images by employing preprocessing for disease diagnosis in accordance with some embodiments of the present.

FIG. 11 illustrates an exemplary block diagram of a computing system in which various aspects of the disclosed techniques may be executed.

### DETAILED DESCRIPTION

The present disclosure relates to techniques for image enhancement or preprocessing as an upstream task, aimed at improving cross-domain generalization ability and robustness of a downstream machine-learning model. According to some aspects, a reference dataset comprising retinal images with a reference style and reference quality may be constructed using an image database. The image database may comprise images that correspond to same or similar domain (e.g., optical coherence tomography (OCT), color fundus photography (CFP) images, or fluorescence angiography (FA) images. The reference style and reference quality may be defined through a combination of automated techniques and an expert input. In particular, domain experts (e.g., ophthalmologists or imaging specialists) may provide qualitative assessments and specify acceptable thresholds for style and quality based on diagnostic relevance for a disease, such as resolution, clarity, contrast, illumination, and absence of artifacts. Additionally, quantitative metrics may be employed, such as signal-to-noise ratio (SNR), sharpness scores, or histography analysis, to objectively evaluate and filter images that meet the requirement.

The combination of expert input and quantitative analysis may enable the construction of the reference dataset that serves as a reliable benchmark for high-quality, diagnostically relevant images. The curated reference dataset may facilitate style removal, quality degradation, and configuration of a cross-domain generalization model that transform degraded images into transformed images. The generated transformed images, consistent in style and quality, may be used by the downstream machine-learning model for better domain adaptability, thereby enhancing performance across diverse datasets.

The preprocessing techniques disclosed herein may be performed as an upstream task to any image-based machine-learning pipeline, enabling consistent input quality and style across diverse datasets, irrespective of variations caused by imaging devices, protocols, or domains. By mitigating domain-specific differences, the technique enhances the performance, adaptability, and robustness of machine-learning models for tasks such as disease diagnosis, classification, and segmentation. Beyond ophthalmology, the disclosed preprocessing techniques may be extended to other applications that rely on image-based machine-learning, including medical imaging (e.g., X-rays, MRIs, CT scans), autonomous driving (e.g., object detection in varying weather conditions), satellite imagery analysis, industrial quality inspection, and facial recognition systems, enabling effective cross-domain adaptation, consistent and reliable model performance across fields where image variability poses a significant challenge.

Cross-domain generalization (or domain adaptability) and robustness may be achieved simultaneously by a machine-learning model such as color fundus photography (CFP)-based deep learning models without the need for target-domain data and extra training-phase adaptation to specific target domains. To achieve this, the reference dataset may be constructed using an image database. Subsequently, degraded images may be generated for each image of the reference dataset by removing the reference style and reducing the reference quality with an image degradation model. A template learning model may be trained using the images of the reference dataset and the degraded images to learn a representation or template of the reference style and the reference quality. The learned template and the degraded images may be utilized by a reverse transformation model to reconstruct the transformed images that align with the reference style and reference quality of the reference dataset. The reverse transformation model along with the style removal and quality degradation may be deployed as for preprocessing the images from the image database for the downstream machine-learning (ML) model. The reverse transformation model may then transform low quality images of different domains to the reference style with enhanced quality to be used in a downstream ML task, for example, classification of retinal fundus images to diagnose eye diseases.

The term “domain” as used herein refers to various variables that may affect the style and quality of the images, such as camera types, ethnicities, populations, imaging parameters, photographing conditions and the like. In addition, the term "style" as used herein typically refers to distinctive visual elements and characteristics that define an overall look and feel of an image. The style of the image may encompass various aspects of visual expression, including composition, color palette, texture, lighting, and other features that contribute to a unique and recognizable appearance of the image. The style may be measured by any image parameter that reflects style, such as color, light intensity, contrast etc. Similarly, the quality of the image may be measured by any possible degradation such as exposure, shadow area, blur, number of artifacts and the like.

The reference dataset may include images of the reference style and the reference quality and may be constructed by selecting images from an image database (e.g., a large CFP repository). The image database may comprise images belonging to a same or similar domain. A human-in-the-loop quality control model may be applied to screen high-quality images with the same style. For example, for eye disease diagnosis using CFP images, multiple senior ophthalmologists’ agreement on the style and quality may be considered as the reference standard. The selected CFP images may then constitute the reference dataset for a subsequent style and quality representation learning by the template learning model.

The style removal and quality degradation may be implemented by the image degradation model that at first degrades the quality of reference images (or the images of the reference dataset). The reference images quality degradation may be performed by simulating poor-quality images from the real-world, by adding different types of random noises, such as blurs, masks, mosaic, and shadow into the image, or adjusting the image color jitter, contrast and illumination. The image degradation model may then remove the style representation while keeping structural invariance of the reference images. The structural invariant style removal may include removing low-frequency components, which reflect the style details and retaining high-frequency components that may represent the structure details. The term “structure” as used herein in the context of images, refers to a spatial arrangement and organization of visual elements within the image. The term structure may cover the distribution of shapes, patterns, and objects, as well as their relationships, orientations, and relative positions. The structural characteristics of an image may define its overall composition, providing information about an arrangement of anatomical features and a visual hierarchy.

The template learning model may be trained to learn the reference style and quality template of the reference images by leveraging a stable subspace representation, which encodes the essential characteristics of the style and quality from the reference dataset for effective generalization. The learning process may be conducted in a self-supervised manner using the reference images and their corresponding degraded versions (i.e., the degraded images). The self-supervised learning task may involve learning a template or representation of the reference images by analyzing and comparing them with their degraded counterparts (e.g., with style removed and quality degraded).

A dissimilarity function may be used as an optimization objective function to train the template learning model. In some instances, the dissimilarity function may be defined as the perceptual dissimilarity. To compute the dissimilarity function, feature vectors may be generated for the original image of the reference dataset and its degraded image by passing both images through a deep model. A distance metric may be computed between feature vectors of the reference image and the degraded image to obtain a perceptual dissimilarity. While in other instances, the dissimilarity function may be defined as the structural dissimilarity index measure (SSIM), which is computed based on luminance, contrast and structure comparison, or the pixel-wise dissimilarity that is computed between pixel values of the reference image and the degraded image. The dissimilarity function may compute more than one image dissimilarity measurement technique to determine the dissimilarity index for training of the template learning model.

The learned template along with the degraded images may be used by a reverse transformation model, that maps the degraded images to reference quality versions using the learned style and quality template. The reverse transformation model may be a generative AI model, including but not limited to auto-encoder, generative adversarial networks, or diffusion models. The model takes the degraded image as input and learns to generate its original counterpart. The image transformation model may eventually capture the style and quality characteristics of the reference dataset, which may serve as the reference for aligning the style and quality of images from new domains to reduce cross-domain variance.

A trained reverse transformation model along with the image degradation model for the style removal and quality degradation may be embedded as an upstream procedure (or preprocessing stage) in an image-based machine learning (ML) pipeline. The upstream procedure or preprocessing stage may map unknown styles and qualities to the learned reference style and quality template.

Some aspects of the present disclosure relate to new training and inference of the image-based machine-learning pipeline. The preprocessing stage may be used during both training and testing of the downstream ML model of the image-based ML pipeline to predict disease diagnosis. For example, for CFP-based eye disease diagnosis task, all CFP images from training and testing datasets for an eye disease diagnosis model may undergo the style removal and quality degradation and a pre-trained reverse transformation model sequentially. Through this preprocessing, the diverse styles of these images (training or testing datasets) may be aligned to the reference style and the reference quality as the images of the reference dataset. In this way, the distributional bias between training and test images may be reduced and the eye disease diagnosis model may be generalized across different domains and robust when facing noisy test samples.

The techniques disclosed in the present disclosure may be utilized with other image-based machine-learning tasks such as retina diseases prediction, glaucoma detection, cardio-vascular diseases classification, melanoma detection, tumor classification etc. The downstream model may include a deep learning model (e.g., deep CNN model such as VGG16 or ResNet etc.) that may be suitable for the image-based machine-learning task. In some other aspects, the image datasets may include several other imaging modalities including but not limited to color fundus photography (CFP), optical coherence tomography (OCT), fluorescence angiography (FA), X-rays, computed tomography (CT) scan, magnetic resonance imaging (MRI), or positron emission tomography (PET) scans.

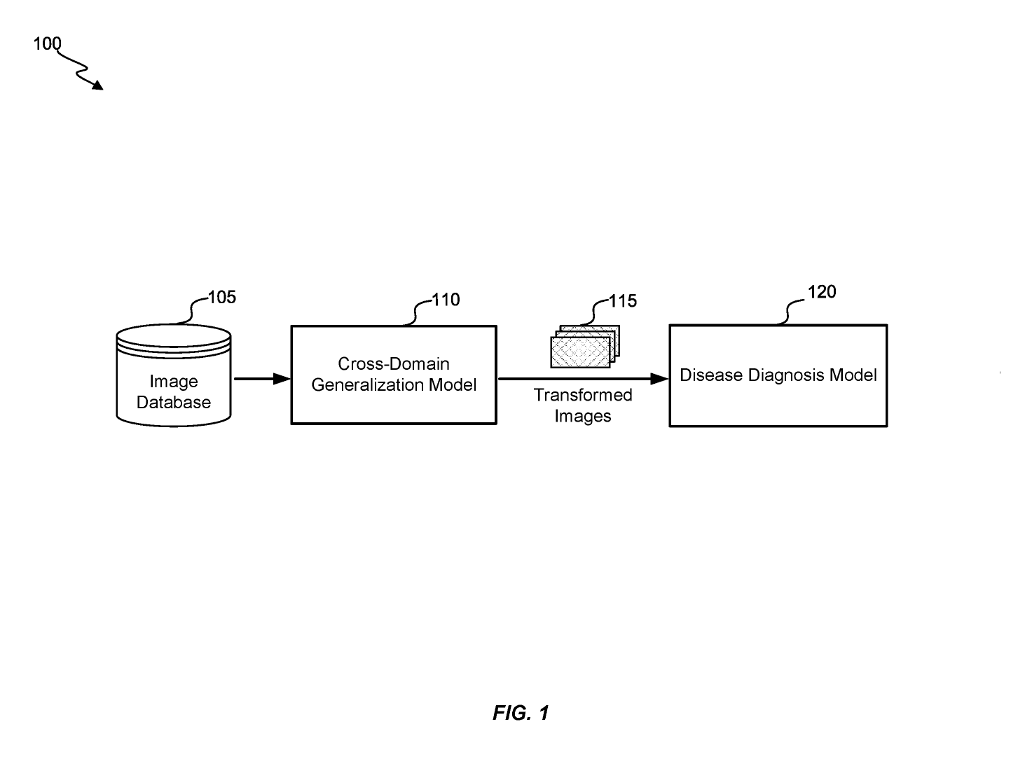

FIG. 1 provides an overview 100 of a cross-domain generalization model employed for preprocessing images in a disease diagnosis model, in accordance with various aspects of the present disclosure. The overview 100 may include an image database 105, a cross-domain generalization model 110, transformed images 115, and a disease diagnosis model 120.

The image database 105 may encompass a collection of retinal images sourced from available databases or repositories. For example, publicly accessible datasets, such as DIARETDB1, Messidor, and the DRIVE Dataset, may provide annotated images for specific eye conditions, including diabetic retinopathy, retinal vascular abnormalities, and other pathologies. Additional databases, such as Kaggle's Blindness Detection Dataset and the Retinal Fundus Image Database (RFMiD), may be accessed to retrieve a diverse range of CFP images designed to support research and model development. Additionally, the image database 105 may also integrate private datasets from clinical or research institutions, offering greater diversity in terms of imaging devices, populations, and imaging conditions. Through this diverse collection, the image database 105 may provide targeted retinal data to train and validate models for robust, domain-agnostic disease diagnosis. The image database 105 may include examples of high-quality fundus photographs (CFP) as well as images exhibiting degraded styles and quality levels to represent real-world scenarios. These images may originate from various domains, such as different imaging devices, clinical settings, or populations, and/or may exhibit variations in style and quality. The image database 105 may be accessed by the cross-domain generalization model 110 to process and transform the images across domains.

The cross-domain generalization model 110 may function as an intermediary preprocessing component for the disease diagnosis model 120. Its primary role may be to regulate the style and quality of images retrieved from the image database 105, reducing the ML model's sensitivity to variations in imaging parameters, domains, or quality, which could otherwise impact downstream analysis. By processing the images, the cross-domain generalization model 110 may align style and quality of the images to a consistent reference, effectively mitigating cross-domain biases.

The transformed images 115 generated by the cross-domain generalization model 110 may then be utilized by the disease diagnosis model 120 for image-based retinal disease prediction and analysis. The preprocessing step (i.e., the cross-domain generalization model 110) may enhance the reliability and adaptability of the disease diagnosis model 120 by ensuring that it receives input images free from domain-specific artifacts and inconsistencies.

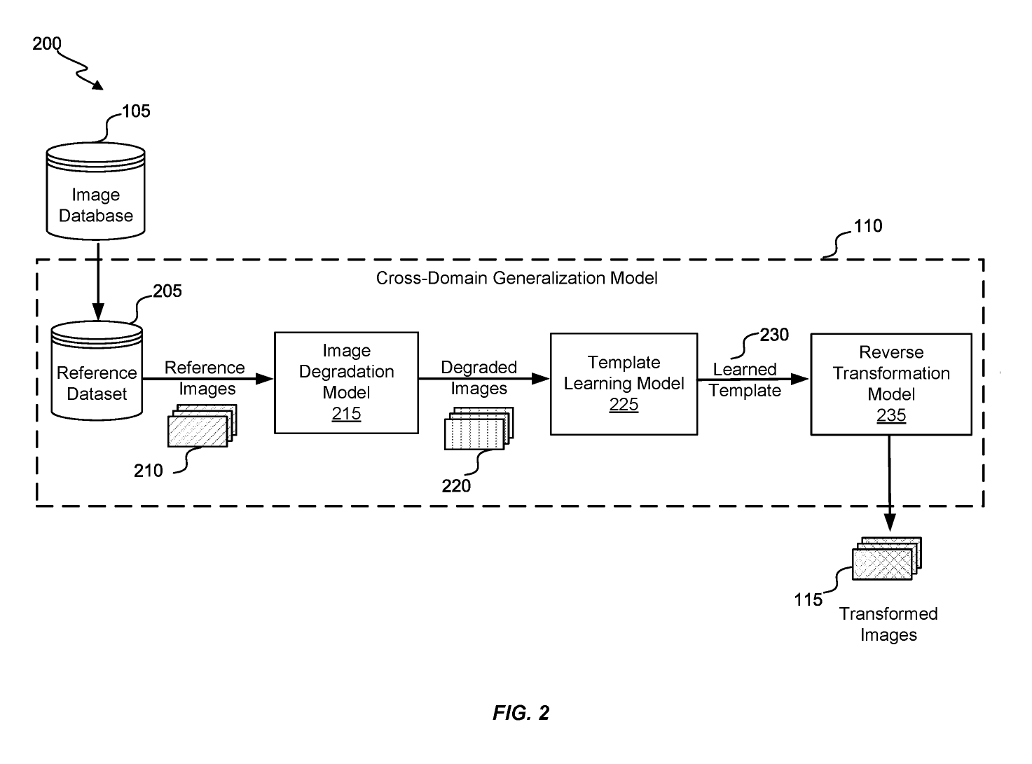

FIG. 2 shows an overview block diagram 200 of the cross-domain generalization model 110 for generating transformed images 115 using the images accessed from the image database 105. The cross-domain generalization model 110 may be initiated by constructing reference dataset 205 from the image database 105. The reference dataset 205 may comprise images representing a consistent domain with a reference style and quality. The reference images 210 may then be processed through an image degradation model 215, which may simulate real-world degradations by altering the style and quality of the reference images. This process may result in the generation of degraded images 220, which may reflect variations commonly observed in practical scenarios, such as noise, blur, shadowing, and style inconsistencies. These degradations may be introduced through systematic transformations applied by the image degradation model 215 and may involve adding random noise, simulating blur through convolutional operations, introducing shadow regions or masks, and altering image attributes (e.g., contrast, brightness, and color balance). Machine-learning models such as variational autoencoders (VAEs) or generative adversarial networks (GANs) may be employed within the image degradation model 215 to create the degraded images 220. These ML models may enable the degraded images 220 to retain structural information while effectively mimicking real-world inconsistencies, allowing the subsequent stages of the cross-domain generalization process to address diverse imaging conditions effectively.

The degraded images 220 may then be utilized by a template learning model 225 to generate a learned template 230 that represents the reference style and quality of reference images 210. Furthermore, the learned template 230 may encapsulate the essential characteristics of the reference images 210 while accounting for their degraded counterparts. This process may leverage self-supervised learning techniques, wherein the template learning model 225 may be trained to identify and encode the reference style and quality template by comparing the reference images 210 with their corresponding degraded versions. Through the self-supervised approach, the template learning model 225 may learn to distinguish invariant features that define the reference style and quality, enabling robust generalization across domains without requiring explicit labels or annotations for the degraded images 220.

Finally, the learned template 230 may be provided to a reverse transformation model 235, which may leverage the template to refine and transform input images into transformed images 115. The transformed images 115 may serve as consistent inputs for downstream machine-learning models, enhancing cross-domain adaptability and robustness regardless of domain-specific variations in image quality or style.

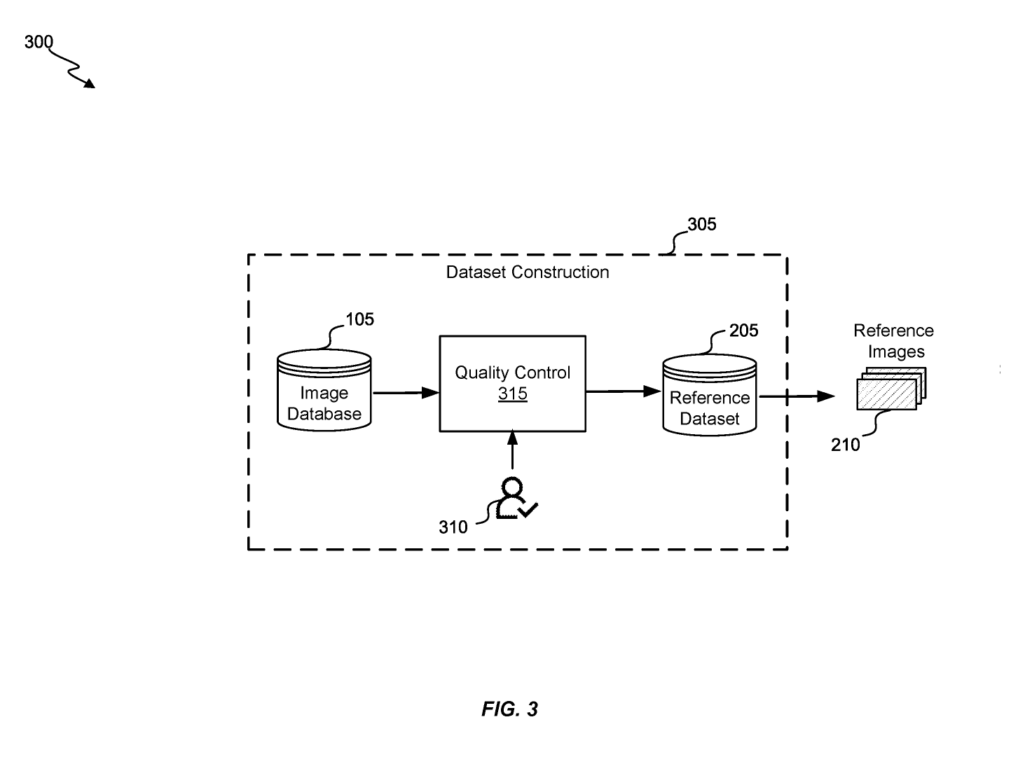

FIG. 3 shows an example block diagram 300 of dataset construction 305 of the reference dataset 205 comprising of images of a reference style and a reference quality in accordance with some embodiments of the present disclosure. The reference dataset 205 may serve as a foundational component for enabling effective style and quality representation learning in subsequent stages of the cross-domain generalization model 110.

The reference dataset 205 may be constructed by carefully selecting images from a larger image database 105, such as a private color fundus photography (CFP) repository. The image database 105 may include a diverse collection of domain-specific images captured under varied conditions. A rigorous quality control process may be applied to identify images that meet the criteria for reference style and quality. This process may involve domain experts employing a structured review protocol or a semi-automated system to assess image consistency. For example, in the context of CFP images for eye disease diagnosis, expert ophthalmologists may evaluate candidate images for adherence to specific criteria, such as optimal color balance, appropriate contrast, and absence of artifacts. Automated tools may assist in pre-screening, flagging images that deviate from these benchmarks, with final approval made by consensus among experts.

In addition to expert evaluations, machine-learning techniques may complement the process, leveraging pre-trained models to detect anomalies, standardizing metadata, and identify candidate images that align with predefined stylistic and quality parameters. By integrating automated pre-selection with manual confirmation, the reference dataset 205 may achieve a high level of reliability and consistency.

Once the images that meet the stringent quality and style criteria may be identified, they may constitute the reference dataset 205. From the reference dataset 205, reference images 210 may be obtained as representative samples for subsequent processing. These reference images 210 may serve as the benchmark for defining and encoding the reference style and quality attributes. The reference images 210 may then be utilized as the input for a subsequent style and quality representation learning phase, which may involve the use of template learning models. The selected images may enable the template learning process to accurately capture the reference attributes that define the reference domain, ensuring robust cross-domain adaptability in downstream applications, such as disease diagnosis using machine-learning models.

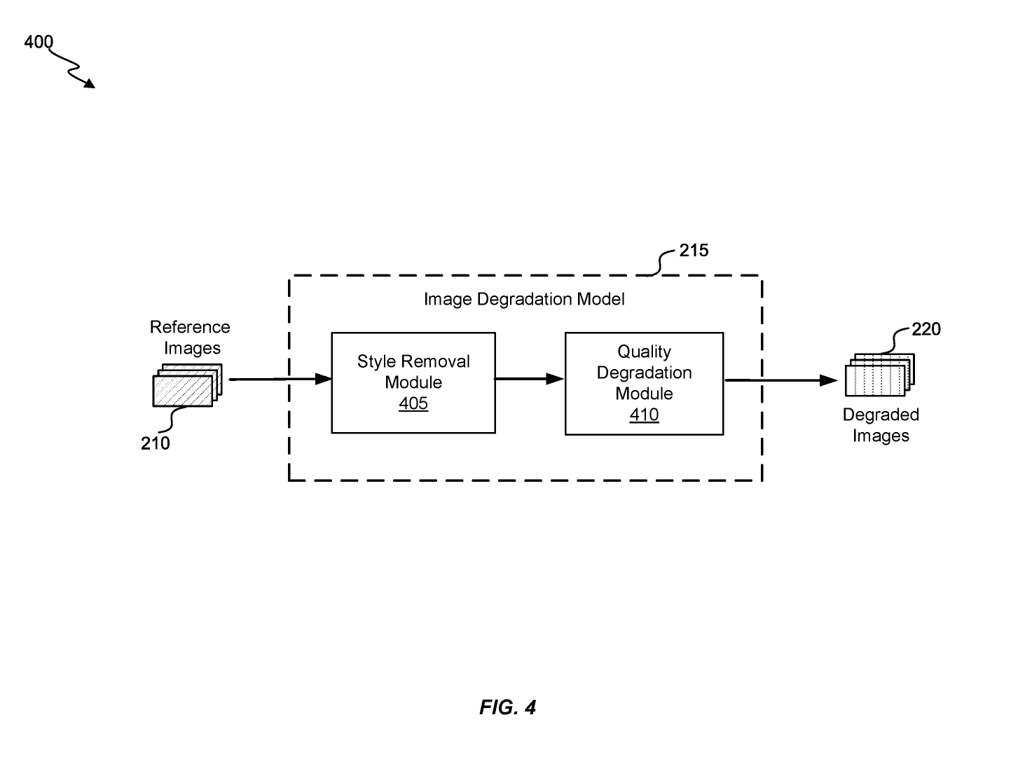

FIG. 4 illustrates exemplary components of the image degradation model 215 configured to perform style removal and quality degradation on the reference images 210, enabling the generation of the degraded images 220. The image degradation model 215 may incorporate specialized submodules, including a style removal module 405 and a quality degradation module 410, each designed to perform distinct yet complementary functions in altering the attributes of the reference images 210.

The style removal module 405 may be responsible for selectively neutralizing stylistic attributes, such as color tones, illumination effects, or texture patterns, that are characteristic of the reference dataset 205. The style removal process may enable the degraded images 220 to retain the structural and content-related features while losing the stylistic uniformity of the reference images 210. Concurrently, the quality degradation module 410 may introduce controlled imperfections, such as noise, blurring, or reduced resolution, to simulate the quality variances commonly observed in images across domains. Together, these modules may collaborate constructively to produce the degraded images 220 that effectively mimic the variability and inconsistencies inherent in real-world datasets.

The output of the image degradation model 215, comprising the degraded images 220, may serve as an input for the subsequent stages of the cross-domain generalization model 110. The degraded images 220 may act as comparative benchmarks against which the template learning model may identify and encode the reference style and quality attributes, facilitating in a comprehensive understanding of the variations present in non-reference data.

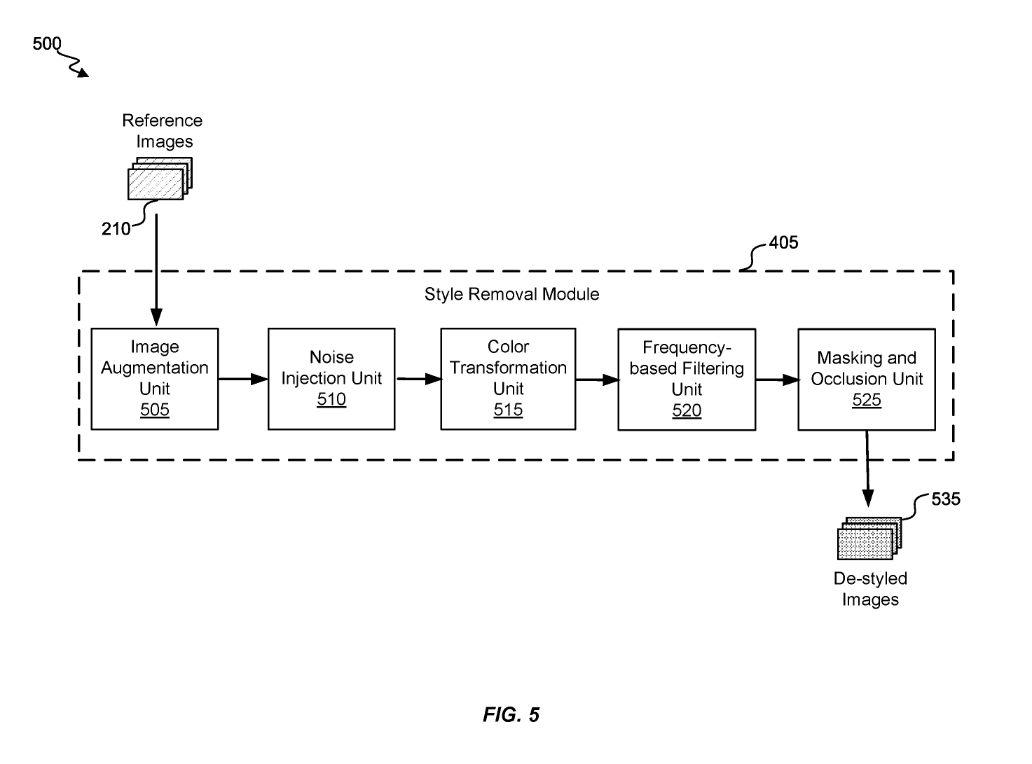

FIG. 5 illustrates an exemplary block diagram 500 of the style removal module 405, designed to process the reference images 210 from the reference dataset 205 for generating the degraded images 220. The style removal module 405 comprises several components, each contributing to the controlled removal of style attributes that mimic real-world fundus images, while preserving the essential structural content of the reference images 210. Main components of the style removal module 405 may include an image augmentation unit 505, a noise injection unit 510, a frequency-based filtering unit 520, a color transformation unit 515, and a masking and occlusion unit 530.

The image augmentation unit 505 may systematically modify attributes such as brightness, contrast, and saturation from the reference images 210. For example, the image augmentation unit 505 may simulate overexposed or underexposed lighting conditions, enhancing domain-specific variations. These augmentations may utilize parametric adjustments or advanced models, such as neural networks, to generate diverse stylistic changes, ensuring that the reference images 210 span a broad stylistic range while preserving their structural details to facilitate robust downstream learning tasks.

Following the image augmentation unit 505, the noise injection unit 510 may introduce stochastic noise patterns, simulating real-world degradations such as sensor artifacts or environmental disturbances, that may include Gaussian noise, representing evenly distributed variations, or salt-and-pepper noise, which mimics sporadic pixel-level disruptions. The noise levels and types are adjustable, ensuring flexibility to emulate diverse imaging conditions. Advanced generative models, such as Variational Autoencoders (VAEs), or Generative Adversarial Networks (GANs), including specialized noise-generation GANs, may be employed to inject noise while preserving high-level structural representations.

Next, the color transformation unit 515 may be employed to manipulate the chromatic properties of the reference images 210 by applying hue shifts, desaturation, or alterations to color balance to mimic differences arising from varied imaging devices or lighting environments. Neural style transfer techniques, such as those leveraging adaptive instance normalization (AdaIN), may facilitate precise color adjustments, enabling consistent and domain-specific degradations.

Complementing the color transformation unit 515 may be the frequency-based filtering unit 520 that may be configured to alter specific frequency components of the reference images 210 to simulate real-world degradations. Low-pass filtering may blur high-frequency details (e.g., fine textures), while high-pass filtering may emphasize edge structures at the cost of overall coherence. The frequency-based filtering unit 520 may use Fourier or wavelet transforms for precision, providing the degraded images 220 with distinct frequency-based characteristics. Finally, the masking and occlusion unit 525 may be used to introduce spatial disruptions such as shadows, reflections, or partial coverage in real-world fundus images. Random masks or pattern-based occlusions may be applied to simulate the spatial disruptions enabling the degraded images 220 to reflect realistic challenges in style attributes while maintaining structural integrity for the downstream machine-learning models. GANs and autoencoders may be trained on large datasets to realistically simulate such occlusions.

The output of the style removal module 405 may include de-styled images 535, that encapsulate the stylistic variations introduced by the aforementioned units. Building upon the de-styled images 535, the quality degradation module 410 may further degrade the quality of the images to produce final degraded images 220.

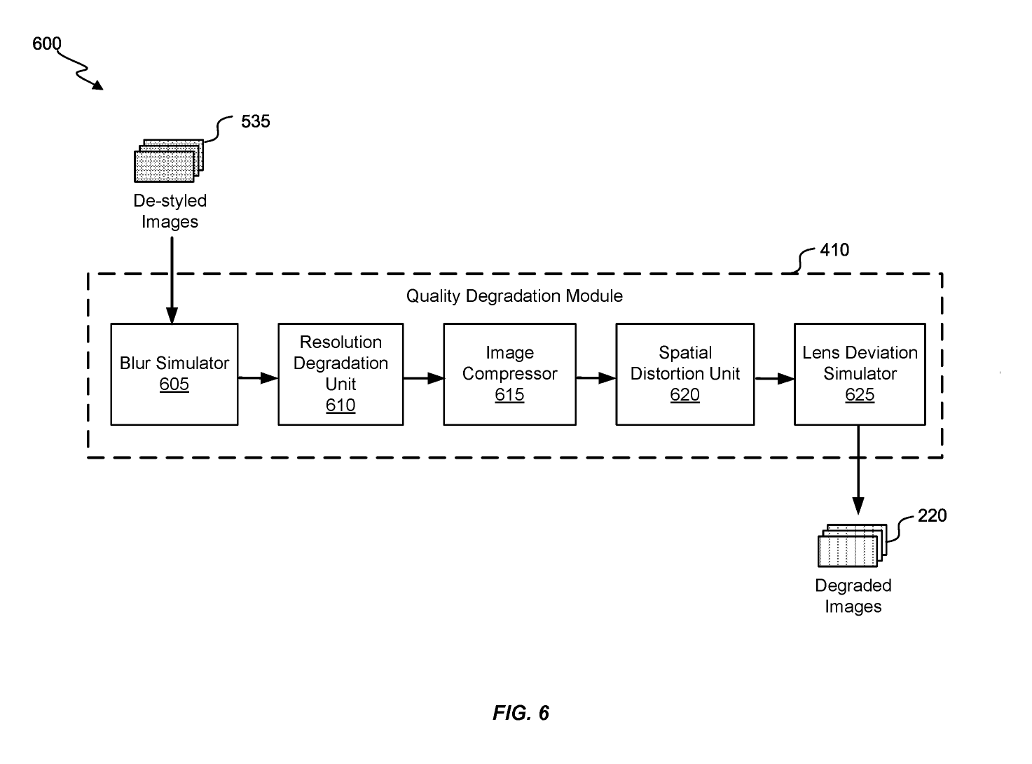

FIG. 6 illustrates a block diagram 600 of the quality degradation module 410 for generating the degraded images 220 in accordance with some embodiments of the present disclosure. The quality degradation module 410 may include a blur simulator 605, a resolution degradation unit 610, an image compressor 615, a spatial distortion unit 620 and a lens deviation simulator. All these components may be employed to introduce a range of realistic quality impairments to reference images 210, thereby generating degraded images 220 that mimic practical quality challenges.

The de-styled images 535, generated from the style removal module 405 may be used by the blur simulator 605 to apply various types of blurring effects, such as Gaussian blur, motion blur, or defocus blur, replicating real-world fundus images. Techniques such as Generative Adversarial Networks (GANs), specifically Pix2Pix GAN or CycleGAN, may be trained to learn blurring patterns from paired or unpaired high- and low-quality fundus images. Alternatively, Fourier Transform-based models may simulate frequency-based blur by attenuating high-frequency components. The models may be trained using large datasets with both synthetic and real-world blurring examples to enable adaptability to different domains.

Next, the resolution degradation unit 610 may simulate loss of image resolution by downscaling and upscaling images using bicubic interpolation or neural network-based methods. Models such as autoencoders or diffusion models may be employed to iteratively degrade resolution, preserving the structure but lowering pixel density. The models may be trained using high-resolution images and their corresponding degraded versions, optimizing for perceptual loss to maintain realism in the degradation.

Following the resolution degradation unit 610, the image compressor 615 may replicate artifacts introduced by lossy compression algorithms, such as JPEG or HEVC, using both rule-based pipelines and neural networks trained on compression tasks. Variational Autoencoders (VAEs) or perceptual loss-guided GANs may be leveraged to introduce compression noise, blocking artifacts, or color banding commonly observed in compressed images. The training process of the aforementioned models may involve datasets of compressed and uncompressed image pairs enabling the compressor to generalize according to diverse scenarios.

After the image compressor 615, the spatial distortion unit 620 may simulate geometric distortions, such as warping, stretching, or perspective shifts. Neural networks trained on spatial transformation tasks, such as Spatial Transformer Networks (STNs), may be utilized to learn patterns of distortion. Rule-based transformations, combined with adversarial networks, may also be employed to apply localized distortions while preserving global image context. Eventually, the lens deviation simulator 625 may replicate optical aberrations such as chromatic aberration, vignetting, or lens distortion. GAN-based approaches or synthetic pipelines utilizing camera-specific calibration data may model these aberrations. Models may be trained using datasets that include images captured with varying lens quality, ensuring the simulated deviations reflect real-world optical artifacts.

Together, the components of the quality degradation module 410 may collaborate effectively to produce degraded images 220 that may accurately emulate a wide range of practical quality issues. By using advanced ML models, the quality degradation module 410 may enable the degraded images 220 to comprehensively represent the challenges posed by real-world CFP conditions, facilitating robust training of downstream models. The degraded images 220 may serve as critical inputs for subsequent learning stages, ensuring the cross-domain generalization model's effectiveness in standardizing diverse input images.

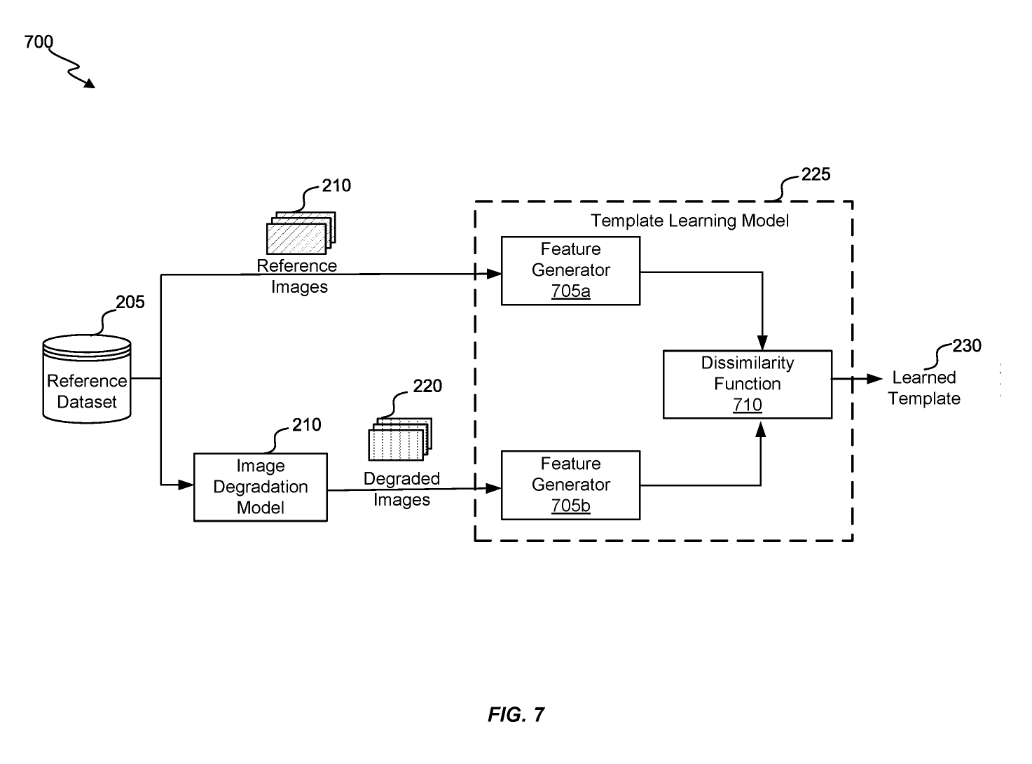

FIG. 7 illustrates a block diagram 700 of learning a template of the reference style and the reference quality by a dissimilarity function using the reference dataset 205, in accordance with some embodiments of the present disclosure. The learning process may begin with the reference dataset 205, that comprises the reference images 210 of the reference style and quality. The reference images 210 may be processed by the image degradation model 215 to generate the degraded images 220. Both the reference images 210 and the degraded images 220 may then be provided as input to the template learning model 225, where features of the images may be analyzed and a learned template 715 may be formulated.

The template learning model 225 may include feature generators 705, that separately process the reference images 210 and the degraded images 220. The feature generators 705 may leverage advanced machine-learning models, such as convolutional neural networks (CNNs), transformer-based architectures, or hybrid neural frameworks, to extract meaningful representations of both sets of images. For instance, the feature generator 705a processing the reference images 210 may focus on capturing their inherent characteristics, such as texture, illumination, and structural patterns. In contrast, the feature generator 705b processing the degraded images 220 may generate features that encode the variations introduced by degradation. The feature generation processes may involve learnable parameters, that may be optimized during the training phase to enable a robust encoding of both reference and degraded images.

The outputs of the feature generators 705a-b may then be input to a dissimilarity function 710 for evaluating the relationship between features of the reference images 210 and the degraded images 220, learning how their differences correlate with the degradations introduced by the image degradation model 215. Instead of simply minimizing a difference metric, the dissimilarity function 710 may employ a representation learning objective, that focuses on identifying the shared and distinct patterns in the features of the two input sets.

In some aspects, the dissimilarity function 710 used in the template learning model 225 may be configured to compare the reference images with their corresponding degraded versions through a combination of perceptual and pixel-wise dissimilarity assessments. Specifically, feature vectors for both the reference image and the transformed degraded image may be generated by passing them through a deep-learning model, such as a convolutional neural network (CNN). These feature vectors encode high-level characteristics of the images, including textures, edges, and other perceptual attributes critical to their style and quality. In some other aspects, to compute perceptual dissimilarity, a distance metric, such as cosine dissimilarity or Euclidean distance, may be applied between the feature vectors of the reference images 210 and the degraded images 220. The distance metric may evaluate the overall contrast of visual features of the degraded image 220 with the reference images 210, enabling the learned template 230 to capture the perceptual essence of the reference dataset 205. Additionally, pixel-wise dissimilarity may be computed by calculating a distance metric, such as mean squared error (MSE) or structural dissimilarity index (DSSIM), between the pixel values of the reference image and its degraded counterpart, enabling alignment at the granular pixel level, capturing finer details and preserving structural integrity. These dual dissimilarity measures may collectively guide the training of the template learning model 225, enabling it to encapsulate both global and local characteristics of the reference images 210. As a result, the learned template 715 may be generated as an output of the dissimilarity function 710, that may be a structured representation of the reference style and quality of the reference images 210. The learned template 715 may store essential features, including high-level structural attributes and low-level stylistic elements.

In some aspects, the learning process for the template may involve iterative optimization methods such as backpropagation, where the dissimilarity function 710 provides feedback to the feature generators 705a-b. The feedback may refine the feature generation process, enabling the learned template 715 to be robust, scalable, and capable of generalizing to unseen datasets.

In practical applications, the learned template 715 may serve as a critical component for reconstructing the transformed images 115. For instance, when the degraded images 220 may be processed through the subsequent reverse transformation model 235, the learned template 230 may provide the essential parameters for restoring the degraded images 220 to their reference style and quality. This approach may have wide-ranging utility in domains such as medical imaging, where accurate generalization and reconstruction of images may be essential for reliable diagnosis.

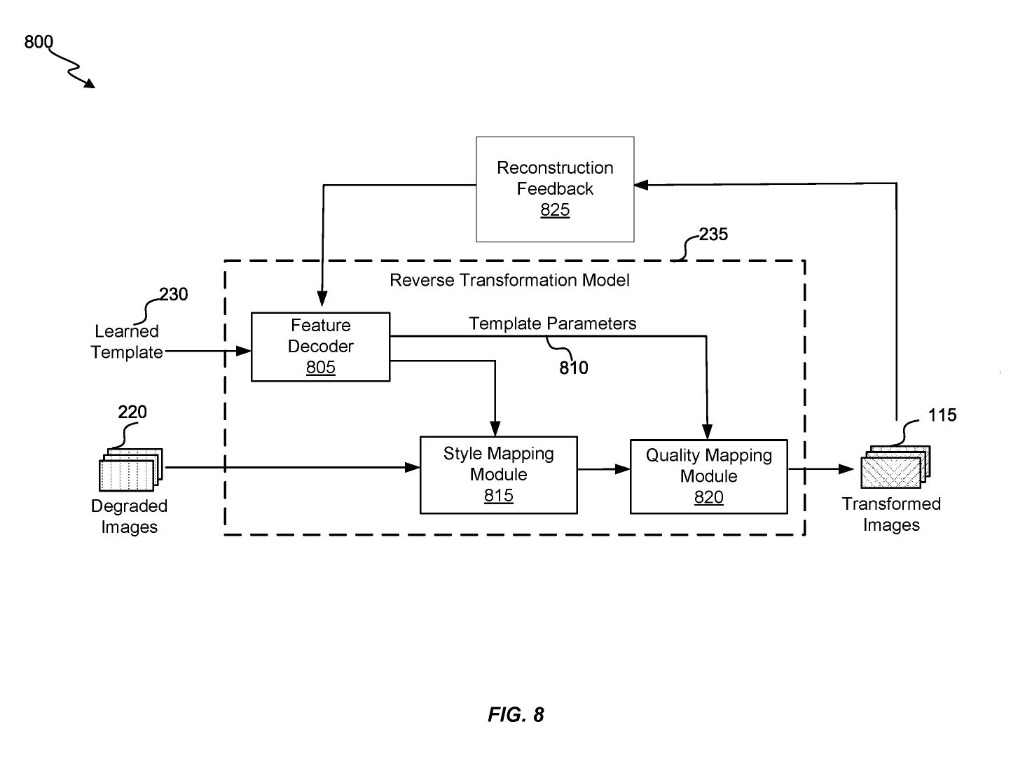

FIG. 8 illustrates a block diagram 800 of the reverse transformation model 235 for generating transformed images 115 based on degraded images 220 and the learned template 230, in accordance with some embodiments of the present disclosure. The reverse transformation model 235 may be employed for reconstructing images that align with the reference style and quality established by the reference images 210 used in earlier stages. By leveraging the learned template 230 and incorporating feedback-based optimization, the reverse transformation model 235 may produce reconstructed transformed images 115 that closely align with the characteristics of the reference images 210.

The reverse transformation model 235 may begin with a feature decoder 805, that may take the learned template 230 as input. The feature decoder 805 may be configured to decode the learned template 230 into template parameters 810, representing essential characteristics of the reference images 210, such as stylistic attributes, structural details, and quality-related features. Advanced machine-learning models, such as autoencoders, transformer decoders, or variational neural networks, may be utilized for the decoding process. These models may be trained on the learned template 230 to enable accurate generation of the parameters needed to reconstruct images with the reference style and quality. The training process of the feature decoder 805 may involve iterative optimization techniques, such as backpropagation, using loss functions that minimize discrepancies between reconstructed transformed images 115 and the reference images 210.

Following the generation of the template parameters 810, the parameters may be combined with the degraded images 220 and passed into a style mapping module 815. The style mapping module 815 may apply transformations to align the stylistic features of the degraded images 220 with those encoded in the template parameters 810. The alignment may involve mapping attributes such as color distribution, texture, and contrast to those of the reference images 210. Neural style transfer models, that may be trained to adapt stylistic elements while preserving content, may be employed in the style mapping module 815. Training these models may use paired or unpaired datasets, where the degraded images 220 and reference images 210 may be compared to learn style transformations. Techniques such as adversarial training, using Generative Adversarial Networks (GANs), or feature-based alignment methods may further enhance the accuracy of the style mapping module 815.

Next, the output from the style mapping module 815 may proceed to a quality mapping module 820. The quality mapping module 820 may address degradations in the structural and pixel-level quality of the degraded images 220. By employing machine-learning models such as diffusion networks, super-resolution frameworks, or autoencoder-based denoising networks, the quality mapping module may be configured to enhance resolution, reduce noise, and correct distortions in the degraded images 220. Both mapping modules (style mapping module 815 and quality mapping module 820) may utilize the template parameters 810 so that the generated transformed images 115 not only achieve high-quality metrics but also conform to the specific standards of the reference dataset 205. Training of the mapping modules may involve loss functions that measure pixel-level differences, perceptual quality metrics, or structural dissimilarity indices, with feedback loops enabling iterative improvement.

The combined output of the style mapping module 815 and the quality mapping module 820 may produce the transformed images 115. The transformed images 115 may exhibit both the stylistic and quality characteristics of the reference images 210, achieving a level of generalization enabling their utility in downstream tasks, such as disease diagnosis or analytical modeling. In some aspects, the transformed images 115 may be indistinguishable from the reference images 210 in terms of the critical features and attributes required for their intended applications.

To enhance the reconstruction process, the reverse transformation model 235 may incorporate reconstruction feedback 825, derived from the transformed images 115 to guide the feature decoder 805 through iterative optimization. By evaluating the output transformed images 115 against the learned template 230 or a subset of the reference images 210, the reverse transformation model 235 may refine its style and quality mapping processes, ensuring convergence toward optimal reconstructions. Feedback-based optimization may rely on loss functions such as style-content loss, perceptual loss, or GAN-based discriminators to guide improvements. Techniques such as backpropagation may adjust the parameters of the feature decoder 805, as well as the style mapping module 815 and the quality mapping module 820, enabling alignment with the required reference quality and style.

The style mapping module 815 and the quality mapping module 820 may operate in tandem, with the template parameters 810 acting as a shared foundation, complementing each other to achieve the required generalization. For example, the style mapping module 815 may prioritize global stylistic corrections, while the quality mapping module 820 may focus on local pixel-level enhancements, together reconstructing images that faithfully mirror the standards of the reference dataset 205.

In some aspects, the reverse transformation model 235 may be particularly beneficial for fields such as medical imaging, where input images belonging to a specific domain, often require restoration to a reference format before analysis. For instance, in color fundus photography (CFP) for eye disease diagnosis, the reverse transformation model 235 may effectively restore the CFP images to match the style and quality of a reference dataset agreed upon by domain experts. This allows for the transformed images 115 to be consistent and reliable for subsequent diagnostic evaluations or algorithmic analysis.

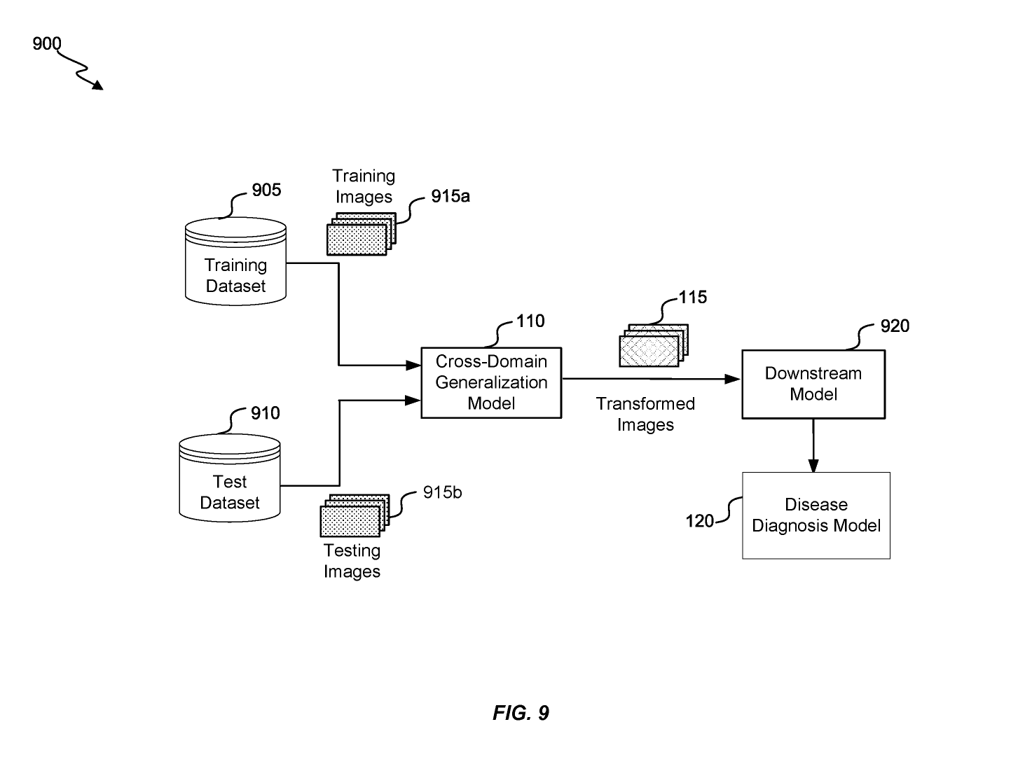

FIG. 9 shows exemplary pipelines of training and testing an image-based disease diagnosis model with cross-domain generalization as preprocessing, in accordance with some embodiments of the present disclosure. The cross-domain generalization model 110 may be embedded as a preprocessing step in an image-based machine-learning pipeline. The preprocessing step may convert an input image (training images 915a or testing images 915b) with different styles and quality into the transformed image 115 with the reference style and the reference quality to be used by a downstream model 920. The preprocessing step may be used during training and testing of the downstream model 920 for predicting various diseases using the disease diagnosis model 120.

In some embodiments, a training dataset 905 may include the training images 915a that belong to the same domain. In some instances, the reference dataset 205 may be a subset of the training dataset 905 and comprises of only those images that meet the reference style and the reference quality which may be determined by domain experts. During the training phase of the downstream model 920, at first the training images 915a style may be removed and the quality may be degraded by the image degradation model 215 (component of the cross-domain generalization model 110). The degraded images 220 (generated from the image degradation model 215) may then be converted into transformed images 115 with the reference style and the reference quality. These transformed images 115 may be used to train the downstream model 920, to be used later in the disease diagnosis model 120. During the testing phase of the downstream model 920, a test dataset 910 that may belong to different or new domain, comprising of testing images 915b with a different style and a different quality than the training images 915a and/or the reference images 210. The preprocessing step may convert the testing images 915b into transformed images 115 having the reference style and the reference quality. In this way, the downstream model 920 may achieve cross-domain generalization and robustness without the need for new domain data and extra training-phase adaptation to the new domain. Moreover, the downstream model 550 may then provide reliable prediction performance across different domains (or on images with different styles and quality).

The training and inference pipeline as shown in FIG. 9, may be used with other image-based machine-learning tasks such as retina diseases prediction, glaucoma detection, cardio-vascular diseases classification, melanoma detection, tumor classification etc. The downstream model 920 may include any machine-learning or deep learning model (e.g., deep CNN model such as VGG16 or ResNet etc.) that may be suitable for the image-based machine-learning task. Moreover, in some other embodiments of the present disclosure, the images may belong to several other imaging modalities including but not limited to color fundus photography (CFP), optical coherence tomography (OCT), fluorescence angiography (FA), X-rays, computed tomography (CT) scan, magnetic resonance imaging (MRI), or positron emission tomography (PET) scans.

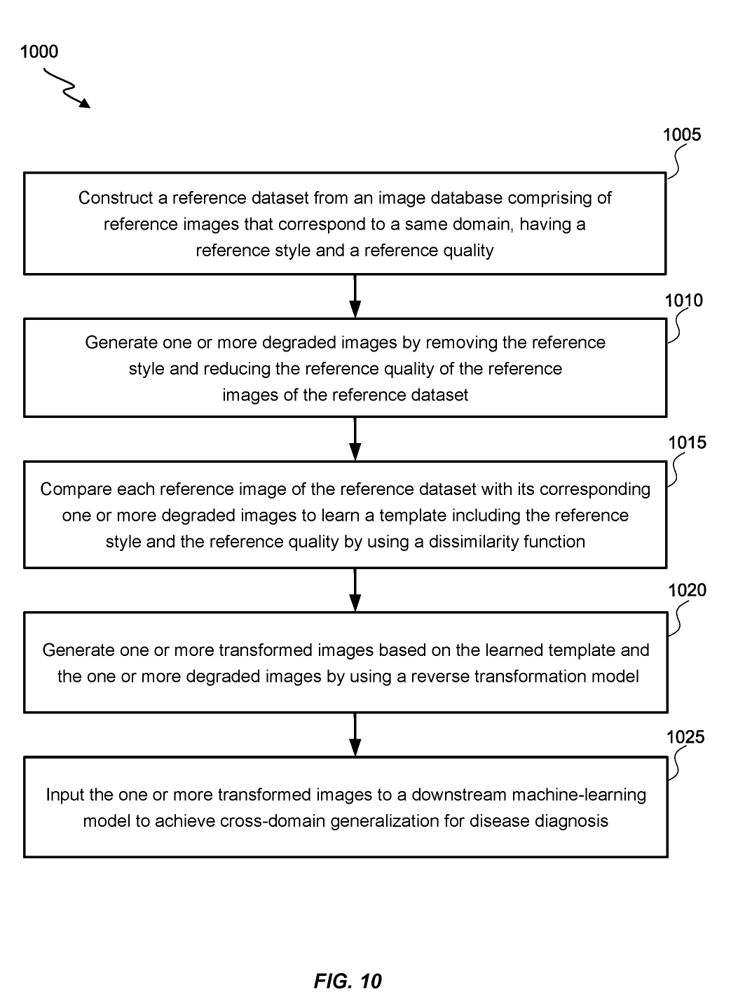

FIG. 10 shows an example flowchart 1000 for generating transformed images 115 by employing preprocessing for disease diagnosis, in accordance with some embodiments of the present. The process block at 1005 may include constructing a reference dataset from an image database, comprising images that belong to the same domain and possess a reference style and reference quality. These images may be selected based on an input from domain experts, who determine the style and quality criteria. Using their input, images adhering to these standards may be identified and included in the reference dataset. In one embodiment, the reference dataset may consist of retina images captured using one or more imaging modalities such as Color Fundus Photography (CFP), Optical Coherence Tomography (OCT), and Fluorescence Angiography (FA). At block 1010, an image degradation model may be configured to generate one or more degraded images of each reference image of the constructed reference dataset by removing the reference style and reducing the reference quality. The image degradation model may consist of a quality degradation module to simulate poor-quality images and a style removal module to eliminate stylistic features while preserving the structural attributes of the reference images. As a result, the image degradation model may generate one or more degraded images corresponding to the reference images.

Subsequently, at block 1015, a template learning model may be utilized to learn a representation or a template of the reference style and quality of the reference images. The learning may be carried out by comparing each of the reference images with their corresponding one or more degraded images using a dissimilarity function. The dissimilarity function may enable both pixel-level and perceptual alignment. For pixel-level alignment, the function may compute a distance metric such as mean squared error (MSE) between the pixel values of the reference images and the degraded images. For perceptual dissimilarity, feature vectors may be generated by passing the images through a deep learning model (e.g., a convolutional neural network). These features vectors may reflect high-level image features, and a distance metric such as cosine dissimilarity or Euclidean distance determines the alignment between the reference images and the degraded images.

Eventually, a reverse transformation model may be configured to generate one or more transformed images based on the one or more degraded images and the learned template, at block 1020. The reverse transformation model, that may employ generative AI techniques, reconstructs the degraded images into transformed images that conform to the reference style and quality. According to some aspects of the present disclosure, the reverse transformation model may leverage self-supervised learning, optimizing itself iteratively based on the degraded images and the learned template.

Finally, at block 1025, the one or more transformed images may be input into a downstream machine-learning model to achieve cross-domain generalization for disease diagnosis. In some aspects, the image degradation model and the reverse transformation model may be deployed as a preprocessing step within a downstream machine-learning pipeline. The preprocessing may enable input images, regardless of their initial style or quality, to be converted into transformed images before training or testing the downstream model. The downstream model, which may include a CFP-based deep learning pipeline, achieves cross-domain generalization, enabling reliable disease diagnosis across diverse datasets. By embedding the preprocessing step, the system enables robust disease prediction even when images originate from varying domains or imaging modalities.

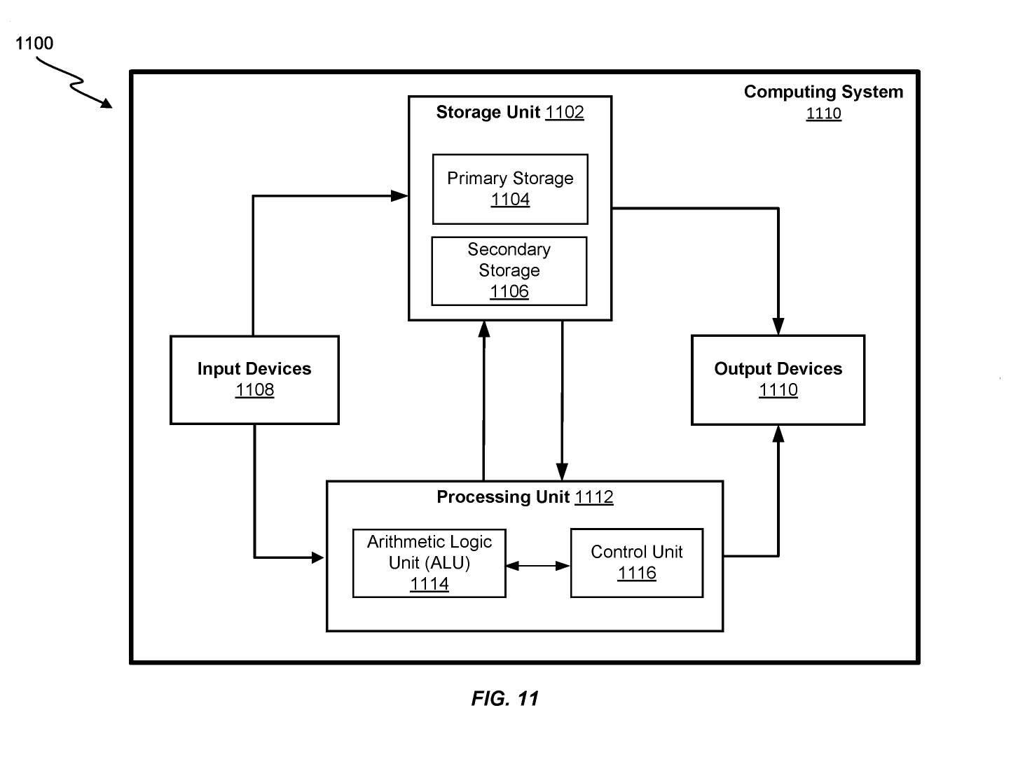

FIG. 11 illustrates an exemplary block diagram of a computing system 1100, in which various embodiments of the present disclosure may be implemented. The functionality described herein may be performed, at least in part or a combination of one or more hardware or software logic components. For example, the techniques described above for generating transformed images using a cross-domain generalization technique by leveraging machine-learning models may be implemented in computer-executable instructions. The instructions may be executed by processing unit 1112 that may be a combination of an arithmetic logic unit 1114 that performs arithmetic and logical operations and a control unit 816 that may help in execution of the instructions. The control unit 1116 may direct and coordinate the operation of the processor with other parts of the computer by synchronizing data flow between different components of the processing unit 1112. It may manage the flow of instructions and data between various components. The control unit 1116 may decode an operation code (opcode) and may convert them into control signals to coordinate how data moves within the processing unit 1112. The control unit 1116 may regulate execution units such as the arithmetic logic unit 1114 and the flow of data to primary storage 1104 and secondary storage 1106.

To provide additional context for various aspects thereof, FIG. 11 and the following description are intended to provide a brief, general description of the computing system in which the various aspects may be implemented. While the description above is in the general context of computer-executable instructions that may run on one or more computing system for implementing various aspects includes a processing unit 1112 having one or more processors (also referred to as microprocessors), a computer-readable storage medium (where the medium is any physical device or material on which data may be electronically and/or optically stored and retrieved) such as a data storage unit 1102 (computer readable storage medium/media also include magnetic disks, optical disks, solid state drives, external memory systems, and flash memory drives), and a system bus. The data storage unit 1102 may have a primary storage 1104 and a secondary storage 1106 as described here in. The primary storage 1104 and the secondary storage 1106 may differ in speed of access, connection with the computer’s processor and data retrieval speeds. Primary storage 1104 may often be directly connected to the computer's processor, boasts rapid data retrieval speeds. In contrast, secondary storage 1106 may be designed for long-term storage and may have slower access times.

The computing system may include various microprocessors, such as a single-processor, multi-processor, single-core, and multi-core units for processing and storage. Additionally, experts in the field recognize that the innovative system and methods may be applied to other computing configurations, including minicomputers, mainframe computers, personal computers (such as desktops, laptops, and tablet PCs), handheld computing devices, microprocessor-based consumer electronics, and similar systems. These systems may be interconnected with one or more associated devices.

In some aspects, the computing system may include one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service (IaaS), platform as a service, software as a service (SaaS), storage as a service (StaaS), data as a service (DaaS), security as a service and APIs (application program interfaces) as a service. In some instances, data storage unit 802 may include computer-readable storage (physical storage) medium such as a volatile memory (e.g., random-access memory (RAM) also termed as the primary storage 804) and a non-volatile memory (e.g., (ROM)). A basic input/output system (BIOS) may be stored in the non-volatile memory and includes the basic routines that facilitate the communication of data and signals between components within the computing system such as during startup. The volatile memory may also includes a high-speed RAM such as static RAM for caching data.

As an illustrative example (without limiting the scope), the data storage unit 1102 may include program modules. These modules may encompass client applications, web browsers, mid-tier applications, relational database management systems (RDBMS), and more. Additionally, the storage unit 1102 holds program data and an operating system. The operating system running may include (for example) Microsoft Windows®, Apple Macintosh®, or Linux. Furthermore, commercially available UNIX®-like operating systems (such as GNU/Linux variants and Google Chrome OS) and mobile operating systems (e.g., iOS, Windows® Phone, Android OS, BlackBerry® OS, and Palm® OS) are part of this landscape. Notably, portions of the operating system, program modules, and program data may be cached in the storage unit 802—both volatile memory (e.g., RAM) and non-volatile memory (e.g., ROM). This flexibility allows the disclosed architecture to be implemented using a variety of commercially available operating systems or combinations thereof (including virtual machines).

In some other examples, the computing system may have additional features or functionality. For example, the computing system may also include additional data storage devices (removable and/ or non-removable) such as, for example, magnetic disks, optical disks, or tape. Computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data.

The storage media of the computing system may also include removable storage, and non-removable storage. EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store the targeted information and which computing system may access are examples of computer storage media in addition to RAM and ROM. Additionally, the computer-readable media might have computer-executable instructions that the processing unit 1112 may use to carry out the different tasks and/or operations mentioned in this article. In contrast, communication media may embody computer readable instructions, data structures, program modules, or other data in a modulated data signal, such as a carrier wave, or other transmission mechanism.

One or more input devices, such as a keyboard, mouse, pen, voice input device, touch input device, etc., may also be included in the computing system. There might also be one or more output devices 1110, including speakers, printers, displays, and so on. These devices are not covered in detail here because they are well known in the field. To establish communication, the computing system may further have one or more network interfaces. This would enable the computing system to communicate with other systems or devices, for example, over a network. Both wired and wireless networks could be a part of these networks. Here, the computing system is one example of a suitable device or system and is not intended to suggest any limitation as to the scope of use or functionality of the various embodiments described.

Other well-known computer environments, configurations, and/or systems that may be appropriate for use with the embodiments include, but are not limited to, network PCs, mainframe computers, programmable consumer electronics, set top boxes, game consoles, programmable consumer electronics, personal computers, server computers, hand-held or laptop devices, multiprocessor systems, microprocessor-based systems, and/or the like. For instance, part or all of the computing system components could be put into use in a cloud computing environment, where resources and/or services are made available for user devices to consume on a selected basis via a computer network.

Further, while certain aspects have been described using a particular combination of hardware and software, it should be recognized that other combinations of hardware and software are also possible. Certain aspects may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation, such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects may provide those skilled in the art with an enabling description for implementing various aspects. Various changes may be made in the function and arrangement of elements.

The specification and drawings are, accordingly, to be regarded in an illustrative rather than a restrictive sense. It may, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

The devices and/or apparatuses described herein may be implemented through the hardware components and software components, and/or a combination thereof. For example, a device may be implemented utilizing one or more general-purpose or special purpose computers, such as, for example, processors, controllers, an arithmetic an logic units (ALUs), application specific integrated circuits (ASICs), digital signal processors (DSPs), digital signal processing devices (DSPDs), programmable logic devices (PLDs), field programmable gate arrays (FPGAs), micro-controllers, microprocessors, programmable logic units (PLUs) or any other electronic device designed to perform the functions described above. The processing device may run an operating system (OS) and one or more software applications that run on the OS. The processing device also may access, store, manipulate, process, and create data in response to execution of the software. For simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

Furthermore, when implemented in software, firmware, middleware, scripting language, and/or microcode, the program code or code segments to perform the necessary tasks may be stored in a machine-readable medium such as a storage medium. The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer-readable recording mediums.

Some embodiments of the present disclosure include a system including one or more data processors. In some embodiments, the system includes a non-transitory computer readable storage medium containing instruction which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The media may also include, alone or in combination with the program instructions, data files, data structures, and the like. The media may continuously store computer executable programs or may temporarily store the same for execution or download. Also, the media may be several types of recording or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD - ROM and DVDs; magneto-optical media such as floptical disks; and hardware devices that are specially configured to store and perform program instructions, such as ROM, RAM, flash memory, and the like. Software codes may be stored in a memory that may be implemented within the processor or external to the processor. As used herein the term “memory” refers to any type of long term, short term, volatile, nonvolatile, or other storage medium and is not to be limited to any memory or number of memories, or type of media upon which memory is stored. Examples of a program instruction may include a machine language code produced by a compiler and a high-language code executable by a computer using an interpreter.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

What is claimed is:

1. A computer-implemented method comprising:
constructing a reference dataset from an image database, wherein the reference dataset comprises reference images that correspond to a same domain, having a reference style and a reference quality;
generating, for each reference image of the reference dataset, one or more degraded images using an image degradation model by removing the reference style and reducing the reference quality of each reference image of the reference dataset;
comparing each reference image of the reference dataset with its corresponding one or more degraded images to learn a template including the reference style and the reference quality by using a dissimilarity function;
generating one or more transformed images based on the one or more degraded images and the learned template by using a reverse transformation model; and
inputting the one or more transformed images to a downstream machine-learning model to achieve cross-domain generalization for disease diagnosis.

2. The computer-implemented method of claim 1, further including:
receiving an input from domain experts on a style and a quality of images of the image database, and
selecting, based on the received input, the images with the reference style and the reference quality to construct the reference dataset.

3. The computer-implemented method of claim 1, wherein the image degradation model comprises:
a quality degradation model to simulate poor-quality images by adding one or more noise types including random noise, blurring, masking, mosaic effect, and shadowing to a reference image of the reference dataset, or by adjusting image color jitter, contrast, and illumination of the reference image; and
a style removal model to remove low-frequency components of the reference image that reflect style while retaining high-frequency components representing structural properties of the images.

4. The computer-implemented method of claim 1, wherein the reverse transformation model is a generative model trained using self-supervised learning to model the template including the reference style and the reference quality based on the reference images of the reference dataset.

5. The computer-implemented method of claim 1, wherein the dissimilarity function further comprises:
generating feature vectors for each reference image of the reference dataset and a corresponding one or more degraded images based on a deep model; and
computing a distance metric for each pair of feature vectors associated with the reference image and the corresponding degraded image to obtain perceptual dissimilarity.

6. The computer-implemented method of claim 1, wherein the downstream machine-learning model includes image-based deep learning pipeline to predict diseases.

7. The computer-implemented method of claim 1, wherein the reference dataset comprises retinal images associated with one or more imaging modalities including color fundus photography (CFP), optical coherence tomography (OCT), and fluorescence angiography (FA).

8. A system comprising:
one or more data processors; and
a non-transitory computer readable storage medium containing instruction which, when executed on the one or more data processors, cause the one or more data processors to perform a set of operations including:
constructing a reference dataset from an image database, wherein the reference dataset comprises reference images that correspond to a same domain, having a reference style and a reference quality;
generating, for each reference image of the reference dataset, one or more degraded images using an image degradation model by removing the reference style and reducing the reference quality of each reference image of the reference dataset;
comparing each reference image of the reference dataset with its corresponding one or more degraded images to learn a template including the reference style and the reference quality by using a dissimilarity function;
generating one or more transformed images based on the one or more degraded images and the learned template by using a reverse transformation model; and
inputting the one or more transformed images to a downstream machine-learning model to achieve cross-domain generalization for disease diagnosis.

9. The system of claim 8, wherein the set of operations further including:
receiving an input from domain experts on a style and a quality of images of the image database, and
selecting, based on the received input, the images with the reference style and the reference quality to construct the reference dataset.

10. The system of claim 8, wherein the image degradation model comprises:
a quality degradation model to simulate poor-quality images by adding one or more noise types including random noise, blurring, masking, mosaic effect, and shadowing to a reference image of the reference dataset, or by adjusting image color jitter, contrast, and illumination of the reference image; and
a style removal model to remove low-frequency components of the reference image that reflect style while retaining high-frequency components representing structural properties of the images.

11. The system of claim 8, wherein the reverse transformation model is a generative model trained using self-supervised learning to model the template including the reference style and the reference quality based on the reference images of the reference dataset.

12. The system of claim 8, wherein the dissimilarity function further comprises:
generating feature vectors for each reference image of the reference dataset and a corresponding one or more degraded images based on a deep model; and
computing a distance metric for each pair of feature vectors associated with the reference image and the corresponding degraded image to obtain perceptual dissimilarity.

13. The system of claim 8, wherein the downstream machine-learning model includes an image-based deep learning pipeline to predict diseases.

14. The system of claim 8, wherein the reference dataset comprises retinal images associated with one or more imaging modalities including color fundus photography (CFP), optical coherence tomography (OCT), and fluorescence angiography (FA).

15. A computer-program product tangibly embodied in a non-transitory machine-readable storage medium, including instructions configured to cause one or more data processors to perform actions including:
constructing a reference dataset from an image database, wherein the reference dataset comprises reference images that correspond to a same domain, having a reference style and a reference quality;
generating, for each reference image of the reference dataset, one or more degraded images using an image degradation model by removing the reference style and reducing the reference quality of each reference image of the reference dataset;
comparing each reference image of the reference dataset with its corresponding one or more degraded images to learn a template including the reference style and the reference quality by using a dissimilarity function;
generating one or more transformed images based on the one or more degraded images and the learned template by using a reverse transformation model; and
inputting the one or more transformed images to a downstream machine-learning model to achieve cross-domain generalization for disease diagnosis.

16. The computer-program product of claim 15, wherein the set of operations further including:
receiving an input from domain experts on a style and a quality of images of the image database, and
selecting, based on the received input, the images with the reference style and the reference quality to construct the reference dataset.

17. The computer-program product of claim 15, wherein the image degradation model comprises:
a quality degradation model to simulate poor-quality images by adding one or more noise types including random noise, blurring, masking, mosaic effect, and shadowing to a reference image of the reference dataset, or by adjusting image color jitter, contrast and illumination of the reference image; and
a style removal model to remove low-frequency components of the reference image that reflect style while retaining high-frequency components representing structural properties of the images.

18. The computer-program product of claim 15, wherein the reverse transformation model is a generative model trained using self-supervised learning to model the template including the reference style and the reference quality based on the reference images of the reference dataset.

19. The computer-program product of claim 15, wherein the downstream machine-learning model includes an image-based deep learning pipeline to predict diseases.

20. The computer-program product of claim 15, wherein the reference dataset comprises retinal images associated with one or more imaging modalities including color fundus photography (CFP), optical coherence tomography (OCT), and fluorescence angiography (FA).
